(19) United States
(12) Patent Application Publication
(10) Pub. No.: US 2021/0210846 A1
(43) Pub. Date: Jul. 8, 2021

(54) RADAR DEVICE

(71) Applicant: Mitsubishi Electric Corporation, Tokyo (JP)

(72) Inventor: Ryota SEKIGUCHI, Tokyo (JP)

(73) Assignee: Mitsubishi Electric Corporation, Tokyo (JP)

(21) Appl. No.: 17/206,744

(22) Filed: Mar. 19, 2021

Related U.S. Application Data
(63) Continuation of application No. PCT/JP2018/035388, filed on Sep. 25, 2018.

(51) Int. Cl. H01Q 1/42; H01Q 1/32; G01S 7/02; G01S 13/931

(52) U.S. Cl. CPC H01Q 1/422; H01Q 1/3233; G01S 2007/027; G01S 13/931; G01S 7/02

(57) ABSTRACT

A radar device includes: an antenna for radiating an electric wave; and a radome used for the antenna, the radome having a first radome layer, a second radome layer arranged opposite to the first radome layer, and a gap layer formed between the first radome layer and the second radome, and the gap between the first radome layer and the second radome layer is set to a value corresponding to one half of the wavelength of the electric wave.

### CROSS REFERENCE TO RELATED APPLICATIONS

This application is a Continuation of PCT International Application No. PCT/JP2018/035388 filed on Sep. 25, 2018, which is hereby expressly incorporated by reference into the present application.

### TECHNICAL FIELD

The present disclosure relates to a radar device.

### BACKGROUND ART

Conventionally, radomes used for antennas in radar devices have been developed. For example, a radome having a so-called “sandwich structure” is disclosed in Patent Literature 1. More concretely, the radome (10) described in Patent Literature 1 has a structure in which one core layer (C) is disposed between two skin layers (S1, S2) (refer to FIG. 1 and so on of Patent Literature 1).

### CITATION LIST

### Patent Literature

Patent Literature 1: JP 2017-79448 A

### SUMMARY OF INVENTION

### Technical Problem

Conventionally, vehicle-mounted radar devices which use a so-called “millimeter wave” (referred to “vehicle-mounted millimeter wave radars” hereinafter) have been developed. In the radomes of vehicle-mounted millimeter wave radars, it is required to achieve an improvement in the transmittance to millimeter waves, and both a reduction in the weight and an improvement in the rigidity.

Here, the invention described in Patent Literature 1 is intended for achieving an improvement in the transmittance to electric waves such as millimeter waves in the radome having a sandwich structure, by setting the thickness of each of the skin layers on the basis of a predetermined mathematical formula (refer to the equation (1) and so on of Patent Literature 1), and also setting the thickness of the core layer on the basis of another predetermined mathematical formula (refer to the equation (2) and so on of Patent Literature 1). More specifically, the invention described in Patent Literature 1 is not intended for achieving a reduction in the weight and an improvement in the rigidity. Therefore, a problem remains in the invention described in Patent Literature 1 from the viewpoint of achieving an improvement in the transmittance to electric waves such as millimeter waves, and both a reduction in the weight and an improvement in the rigidity.

For example, in case the radome described in Patent Literature 1 is used for a vehicle-mounted millimeter wave radar, because the frequencies of millimeter waves are equal to or greater than 30 gigahertz (described as “GHz” hereinafter), there is a case in which the thickness of the core layer is set to be equal to or less than 2.5 millimeters (described as “mm” hereinafter) on the basis of the equation (2) of Patent Literature 1. Because the core layer is thin, as mentioned above, in the case in which each of the skin layers is formed so as to be thin (i.e. in the case of decreasing the value of n in the equation (1) of Patent Literature 1), although it is easy to achieve a reduction in the weight of the radome, it is difficult to achieve an improvement in the rigidity of the radome. In contrast, in the case in which each of the skin layers is formed so as to be thick (i.e. in the case of increasing the value of n in the equation (1) of Patent Literature 1), although it is easy to achieve an improvement in the rigidity of the radome, it is difficult to achieve a reduction in the weight of the radome.

The present disclosure is made in order to solve the above-mentioned problem, and it is therefore an object of the present disclosure to provide a technique of, in a radome for radar devices used for vehicles or the likes, achieving an improvement in the transmittance to electric waves, such as millimeter waves, and both a reduction in the weight and an improvement in the rigidity.

### Solution to Problem

The radar device of the present disclosure includes: an antenna for radiating an electric wave; and a radome used for the antenna, the radome having a first radome layer, a second radome layer arranged opposite to the first radome layer, the second radome layer being the same in material and thickness as the first radome layer, and a gap layer formed between the first radome layer and the second radome, and the gap between the first radome layer and the second radome layer is set to a value corresponding to one half of the wavelength of the electric wave, thereby maximizing transmittance of the radome at a carrier frequency of electric wave.

### Advantageous Effects of Invention

According to the present disclosure, because the radar device is constructed as above, it is possible to achieve an improvement in the transmittance to electric waves such as millimeter waves, and both a reduction in the weight and an improvement in the rigidity in the radome for the radar device used for vehicles or the likes.

### BRIEF DESCRIPTION OF DRAWINGS

FIG. 1 is a front view showing a main part of an antenna for use in a radar device according to Embodiment 1;

FIG. 2A is a front view showing a main part of the radar device according to Embodiment 1;

FIG. 2B is a cross-sectional view taken along the line A-A′ shown in FIG. 2A;

FIG. 3 is a characteristic diagram showing the transmittance of a radome for use in the radar device according to Embodiment 1 to millimeter waves;

FIG. 4 is a characteristic diagram showing the transmittance of another radome for use in the radar device according to Embodiment 1 to millimeter waves;

FIG. 5 is a characteristic diagram showing the transmittance of a radome to millimeter waves, the radome being provided for comparison with the radome for use in the radar device according to Embodiment 1;

FIG. 6 is a characteristic diagram showing the transmittance of another radome for use in the radar device according to Embodiment 1 to millimeter waves;

FIG. 7A is a front view showing a main part of a radar device according to Embodiment 2;

FIG. 7B is a cross-sectional view taken along the line A-A′ shown in FIG. 7A;

FIG. 8 is a characteristic diagram showing the transmittance of a radome for use in the radar device according to Embodiment 2 to millimeter waves; and

FIG. 9 is a characteristic diagram showing the transmittance of another radome for use in the radar device according to Embodiment 2 to millimeter waves.

### DESCRIPTION OF EMBODIMENTS

Hereinafter, in order to explain the present disclosure in greater detail, embodiments of the present disclosure will be described with reference to the accompanying drawings.

### Embodiment 1

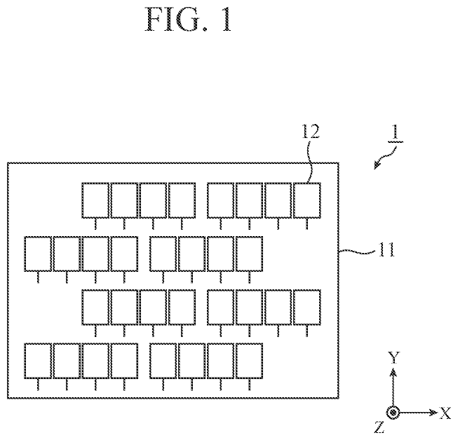

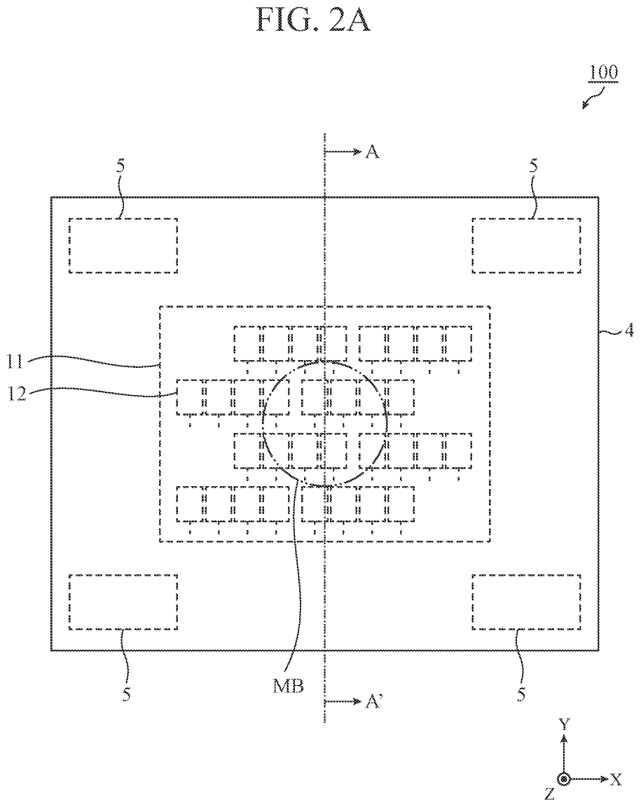

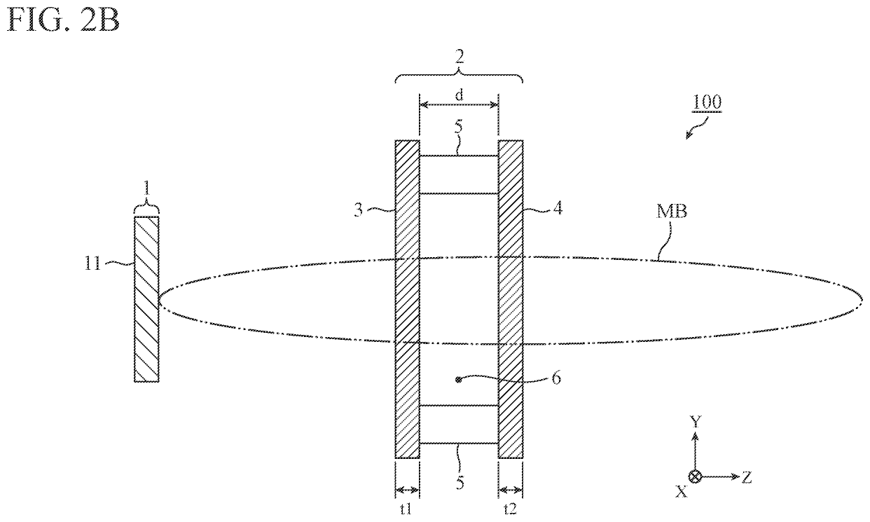

FIG. 1 is a front view showing a main part of an antenna for use in a radar device according to Embodiment 1. FIG. 2A is a front view showing a main part of the radar device according to Embodiment 1. FIG. 2B is a cross-sectional view taken along the line A-A′ shown in FIG. 2A. Referring to FIGS. 1 and 2, the radar device 100 of Embodiment 1 will be explained focusing on an example in which the radar device is used as a vehicle-mounted millimeter wave radar. More specifically, the radar device 100 is mounted in a vehicle (not illustrated).

In the figures, 1 denotes the antenna. The antenna 1 radiates an electric wave having a predetermined frequency f (e.g. 77 GHz), i.e. a millimeter wave. When the radiated electric wave is reflected by an obstacle (not illustrated) outside the vehicle, the antenna 1 receives the reflected electric wave. A control unit (not illustrated) measures the distance between the vehicle and the obstacle on the basis of the difference value Δf between the frequency f of the electric wave radiated by the antenna 1 and the frequency f′ of the electric wave received by the antenna 1. The control unit consists of, for example, an electronic control unit (ECU).

Hereinafter, an electric wave to be radiated by the antenna 1 and an electric wave radiated by the antenna 1 are generically referred to as a “radiation wave”. Further, the frequency f of the electric wave to be radiated by the antenna 1, i.e. the frequency f of the radiation wave may be referred to as the “carrier frequency”.

The antenna 1 consists of, for example, a so-called “planar array antenna”. In the example shown in FIGS. 1 and 2, multiple antenna elements 12 are arranged on a surface portion of a substrate 11 in a planar form, i.e. in a two-dimensional array.

The direction of radiation of a main electric wave (a so-called “main beam”) of the radiation wave (the so-called “direction of the main beam”) is set so as to, for example, be perpendicular or substantially perpendicular to a plate surface of the substrate 11, i.e. so as to extend along a Z axis in the figures. In the figures, MB denotes a region corresponding to the main beam, i.e. a region through which the main beam is to pass.

The radar device 100 has a radome 2 used for the antenna 1. The radome 2 is arranged opposite to the surface portion of the substrate 11. More specifically, the radome 2 is arranged opposite to the multiple antenna elements 12. Hereinafter, the radome 2 will be explained.

As shown in FIG. 2, the radome 2 has two radome layers 3 and 4 arranged opposite to each other. Each of the two radome layers 3 and 4 is disposed in parallel with or in substantially parallel with the plate surface of the substrate 11, for example. In the figure, t1 denotes the thickness of one radome layer (which may be referred to as the “first radome layer” hereinafter) 3, out of the two radome layers 3 and 4. In the figure, t2 denotes the thickness of the other radome layer (which may be referred to as the “second radome layer”) 4, out of the two radome layers 3 and 4.

The radome layers 3 and 4 are constructed of, for example, fiber-reinforced plastic, such as fiberglass reinforced plastic or quartz fiber-reinforced plastic.

Because these types of fiber-reinforced plastic have a relatively small dielectric loss, they are suitable for use in the radome layers 3 and 4. Usually, the dielectric constants of these types of fiber-reinforced plastic are approximately 2.0 to 6.0. For example, the dielectric constants of parts excluding fibers for reinforcement (i.e. parts constructed of plastic), out of these types of fiber-reinforced plastic, are approximately 2.0. Further, the dielectric constant of fiberglass reinforced plastic having a high volume fraction of fiber is approximately 6.0.

One or more supporting members 5 are disposed between the first radome layer 3 and the second radome layer 4. As a result, a gap layer 6 is formed between the first radome layer 3 and the second radome layer 4. In the example shown in FIG. 2, four supporting members 5 are disposed between the first radome layer 3 and the second radome layer 4. The supporting members 5 are constructed of, for example, plastic, fiber-reinforced plastic reinforced with one of various fibers, or metal such as aluminum.

The supporting members 5 are arranged outside the region in the radome 2 through which the radiation wave is to pass. More concretely, the supporting members 5 are arranged outside the region MB in the radome 2 through which the main beam is to pass.

Air is contained in the gap layer 6. Usually, the dielectric constant of the air is approximately 1.0. More specifically, the dielectric constant of the gap layer 6 (approximately 1.0) is less than the dielectric constants of the radome layers 3 and 4 (approximately 2.0 to 6.0).

Here, the gap d between the first radome layer 3 and the second radome layer 4, more concretely, the gap d with respect to a direction of the thicknesses of the radome layers 3 and 4 (i.e. a direction extending along the Z axis in the figures) is set to a value corresponding to an integral multiple of one half of the wavelength of the radiation wave in the gap layer 6. More concretely, the gap d is set to a value based on the following equation (1).

d=α×(n×λ₀/2) (1)

λ₀ is the wavelength of the radiation wave in a vacuum. n is an arbitrary integer equal to or greater than 1. α is a coefficient satisfying the condition shown in the following equation (2).

0.8≤α≤1.2 (2)

The main part of the radar device 100 is constructed in this way.

Next, advantages provided through the use of the radome 2 in the radar device 100 will be explained.

First, because the layer having a low dielectric constant (i.e. the gap layer 6) is disposed between the first radome layer 3 and the second radome layer 4, an improvement in the transmittance to electric waves such as millimeter waves can be achieved. Secondly, because the gap layer 6 is formed between the first radome layer 3 and the second radome layer 4, a reduction in the weight of the radome 2 can be achieved. Thirdly, because this gap layer 6 is formed, the supporting members 5 can be disposed between the first radome layer 3 and the second radome layer 4. Therefore, the use of a material suitable for the supporting members 5 makes it possible to achieve an improvement in the rigidity of the radome 2 while achieving a reduction in the weight of the radome 2.

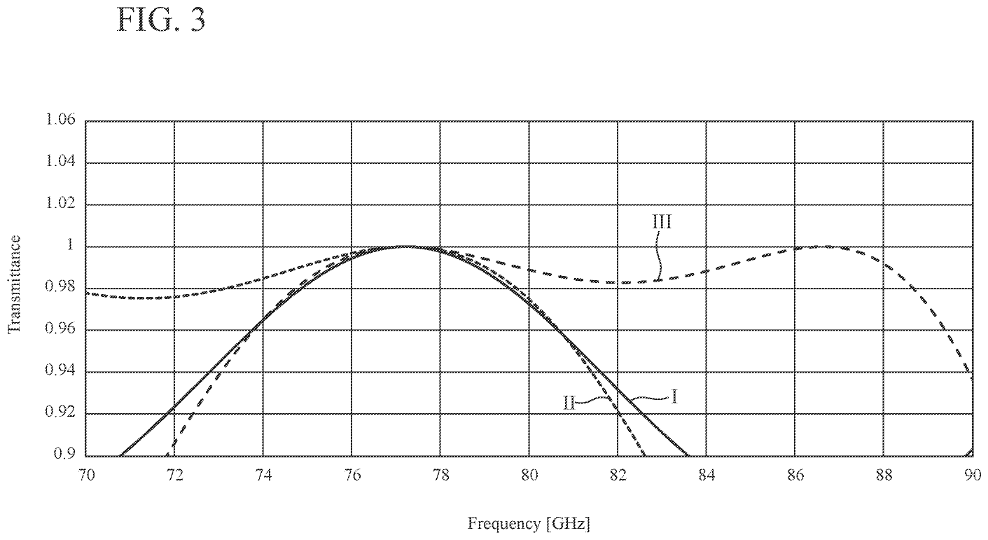

Further, because the gap d between the first radome layer 3 and the second radome layer 4 is set to the value based on the equation (1), the transmittance of the radome 2 to millimeter waves can be maximized at the carrier frequency f (e.g. 77 GHz). As a result, the Fresnel loss in a predetermined frequency range including the carrier frequency f can be reduced to 5% or less, as will be mentioned later by reference to FIGS. 3 to 6.

In FIGS. 3 to 6, each of characteristic lines I, II, III, IV, and VI shows the transmittance of the radome 2 to millimeter waves. Further, a characteristic line V shows the transmittance of a radome 2′ (not illustrated) to millimeter waves, the radome 2′ being provided for comparison with the radome 2. These transmittance to millimeter waves are calculated using the so-called “Fresnel equations”. In the calculation of these transmittance to millimeter waves, the dielectric loss is neglected and the Fresnel loss is set as a target for the calculation. This is because the dielectric loss is small compared with the Fresnel loss.

The radome 2′ is constructed of the same material as that of the radome 2. However, the gap d in the radome 2′ is set to a value corresponding to one quarter of the wavelength of the radiation wave in the gap layer. More concretely, the gap d in the radome 2′ is set to a value based on the following equation (3).

d=λ₀/4 (3)

In the radome 2 associated with the characteristic line I, the radome layers 3 and 4 are constructed of fiberglass reinforced plastic. The dielectric constant of this fiberglass reinforced plastic is 4.0. In the radome 2 associated with the characteristic line I, the gap is set to d=1.95 mm (more specifically, in the case of f=77 GHz, and n=1 and α=1.0). In the radome 2 associated with the characteristic line I, the thicknesses are set to t1=t2=0.97 mm. Hereinafter, the example of the structure of the radome 2 associated with the characteristic line I is referred to as the “first structure example”.

In the radome 2 associated with the characteristic line II, the radome layers 3 and 4 are constructed of the same material as that in the first structure example. In the radome 2 associated with the characteristic line II, the gap is set to d=1.56 mm (more specifically, in the case of f=77 GHz, and n=1 and α=0.8). In the radome 2 associated with the characteristic line II, the thicknesses are set to t1=t2=0.97 mm. Hereinafter, the example of the structure of the radome 2 associated with the characteristic line II is referred to as the “second structure example”.

In the radome 2 associated with the characteristic line III, the radome layers 3 and 4 are constructed of the same material as that in the first structure example. In the radome 2 associated with the characteristic line III, the gap is set to d=2.34 mm (more specifically, in the case of f=77 GHz, and n=1 and α=1.2). In the radome 2 associated with the characteristic line III, the thicknesses are set to t1=t2=0.97 mm. Hereinafter, the example of the structure of the radome 2 associated with the characteristic line III is referred to as the “third structure example”.

As shown in FIG. 3, even in the case of using any one of the radome 2 of the first structure example, the radome 2 of the second structure example, and the radome 2 of the third structure example, the Fresnel loss in the frequency range of 73 to 81 GHz can be reduced to 5% or less. More specifically, not only in the case of α=1.0, but also in the case in which α is within the range satisfying the condition shown in the equation (2), an advantage of achieving an improvement in the transmittance to millimeter waves is provided even in the case of α≠1.0. This shows that not only in the case in which the direction of the main beam of the antenna 1 is set so as to extend along the direction of the thicknesses of the radome layers 3 and 4 (i.e. extend along the Z axis), but also in the case in which the direction of the main beam is set so as to be slightly inclined against the thickness direction, an advantage of achieving an improvement in the transmittance to millimeter waves is provided.

In the radome 2 associated with the characteristic line IV, the radome layers 3 and 4 are constructed of the same material as that in the first structure example. In the radome 2 associated with the characteristic line IV, the gap is set to d=1.95 mm (more specifically, in the case of f=77 GHz, and n=1 and α=1.0). In the radome 2 associated with the characteristic line IV, the thicknesses are set to t1=t2=0.49 mm. Hereinafter, the example of the structure of the radome 2 associated with the characteristic line IV is referred to as the “fourth structure example”.

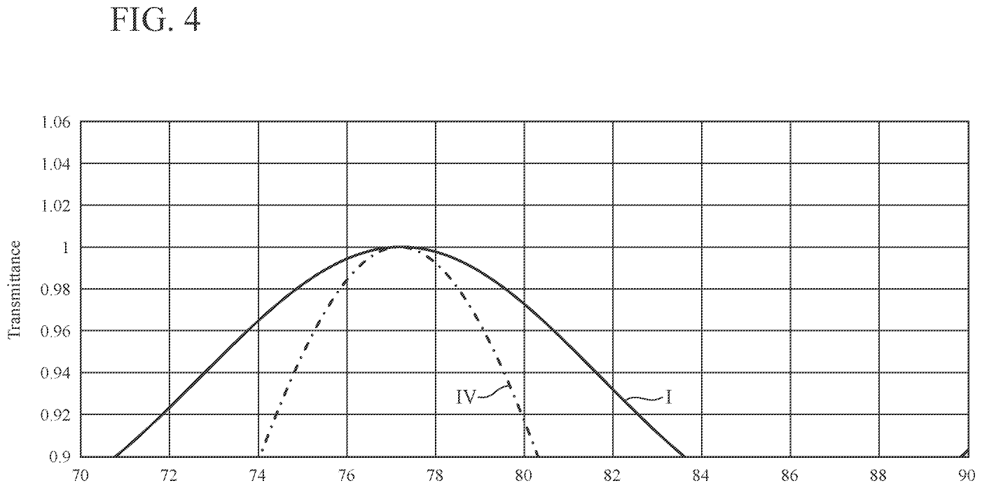

More specifically, the radome 2 of the fourth structure example differs from the radome 2 of the first structure in the values of the thicknesses t1 and t2. As shown in FIG. 4, the use of the radome 2 of the first structure example makes it possible to reduce the Fresnel loss in the frequency range of 73 to 81 GHz to 5% or less. In contrast with this, even in the case of using the radome 2 of the fourth structure example, the Fresnel loss in the frequency range of 75 to 79 GHz can be reduced to 5% or less.

In the radome 2′ associated with the characteristic line V, the radome layers (more concretely, the first radome layer and the second radome layer) are constructed of the same material as that in the first structure example. In the radome 2′ associated with the characteristic line V, the gap is set to d=0.97 mm (more specifically, the gap d is set to the value based on the equation (3)). In the radome 2′ associated with the characteristic line V, the thicknesses are set to t1=t2=0.49 mm. Hereinafter, the example of the structure of the radome 2′ associated with the characteristic line V is referred to as the “fifth structure example”.

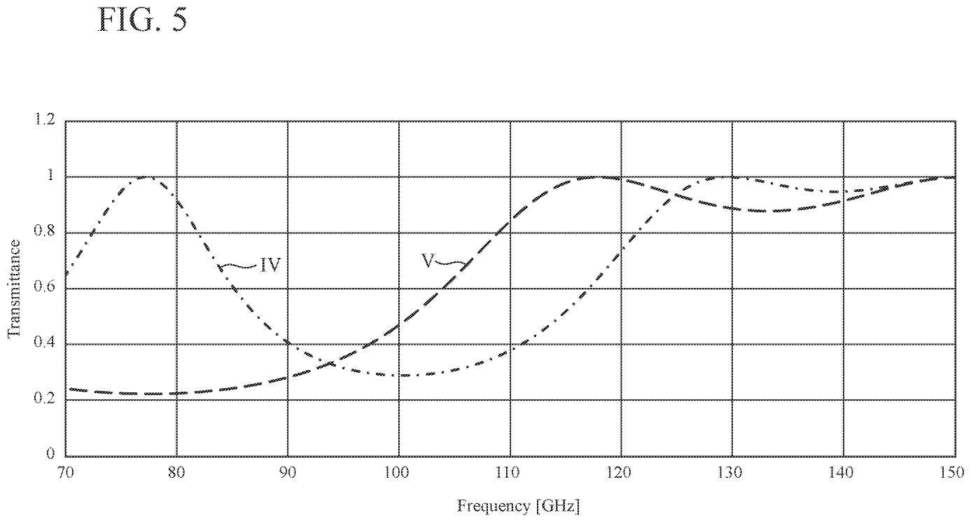

As shown in FIG. 5, in the case of using the radome 2′ of the fifth structure example, the transmittance to millimeter waves in the predetermined frequency range including 77 GHz (more concretely, in at least a frequency range of 70 to 90 GHz) is low as compared with the case of using the radome 2 of the fourth structure example. In other words, in the case of using the radome 2 of the fourth structure example, the transmittance to millimeter waves in this frequency range can be improved as compared with the case of using the radome 2′ of the fifth structure example.

In the radome 2 associated with the characteristic line VI, the radome layers 3 and 4 are constructed of the same material as that in the first structure example. In the radome 2 associated with the characteristic line VI, the gap is set to d=3.90 mm (more specifically, in the case of f=77 GHz, and n=2 and α=1.0). In the radome 2 associated with the characteristic line VI, the thicknesses are set to t1=t2=0.97 mm. Hereinafter, the example of the structure of the radome 2 associated with the characteristic line VI is referred to as the “sixth structure example”.

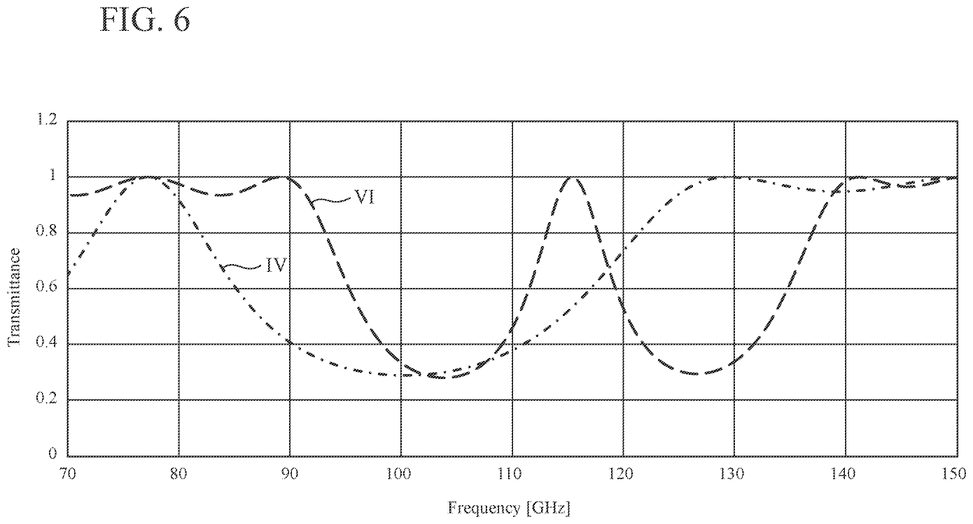

More specifically, the radome 2 of the sixth structure example differs from the radome 2 of the fourth structure example in the value of the integer n and the values of the thicknesses t1 and t2. As shown in FIG. 6, the use of the radome 2 of the fourth structure example makes it possible to reduce the Fresnel loss in the frequency range of 75 to 79 GHz to 5% or less. In contrast with this, the use of the radome 2 of the sixth structure example makes it possible to reduce the Fresnel loss in the frequency range of 72 to 82 GHz to 5% or less.

Further, in the radome 2 of the sixth structure example, because the gap d is large (d=3.90 mm) in spite of the carrier frequency f being high (f=77 GHz), the size of the supporting members 5 with respect to the direction of the thicknesses of the radome layers 3 and 4 (i.e. the direction extending along the Z axis) can be increased. More specifically, the thick supporting members 5 having such a size of approximately 4 mm can be used, and the gap layer 6 can be enlarged. As a result, an improvement in the rigidity of the radome 2 can be easily achieved while the increase in the weight of the radome 2 is suppressed.

The material of the radome layers 3 and 4 is not limited to fiber-reinforced plastic, such as fiberglass reinforced plastic or quartz fiber-reinforced plastic. The radome layers 3 and 4 may be formed using a material different from these types of fiber-reinforced plastic as long as the material has a dielectric loss as small as those of these types of fiber-reinforced plastic.

Further, the material of the supporting members 5 is not limited to plastic, fiber-reinforced plastic, or metal. The supporting members 5 may be formed using any type of material as long as the material is suitable from the viewpoint of achieving a reduction in the weight of the radome 2 and an improvement in the rigidity of the radome 2.

Further, the radiation wave is not limited to a millimeter wave, and the carrier frequency f is not limited to 77 GHz. The antenna 1 may be one which radiates an electric wave having an arbitrary frequency f as long as the frequency f can be used in the radar device 100. For example, the antenna 1 may be one which radiates a so-called “microwave” or “submillimeter wave”.

Further, the radar device 100 is not limited to a vehicle-mounted one, and the use of the radar device 100 is not limited to measurements of the distance between the vehicle and an obstacle. The radar device 100 may be one used for radars for any purpose.

As mentioned above, the radar device 100 of Embodiment 1 includes the antenna 1 for radiating an electric wave, and the radome 2 used for the antenna 1, the radome 2 having the first radome layer 3, the second radome layer 4 arranged opposite to the first radome layer 3, and the gap layer 6 formed between the first radome layer 3 and the second radome layers 4, and the gap d between the first radome layer 3 and the second radome layer 4 is set to a value corresponding to an integral multiple of one half of the wavelength of the electric wave. The structure in which the radome 2 has the gap layer 6 makes it possible to achieve an improvement in the transmittance to electric waves such as millimeter waves and a reduction in the weight of the radome 2, and to dispose the supporting members 5 between the first radome layer 3 and the second radome layer 4. Therefore, the use of a material suitable for the supporting members 5 makes it possible to achieve an improvement in the rigidity of the radome 2 while achieving a reduction in the weight of the radome 2. Further, because the gap d is set to the value based on the equation (1), the Fresnel loss in the predetermined frequency range including the carrier frequency f can be reduced.

Further, the gap d extends with respect to the direction of radiation of the electric wave by the antenna 1 (more concretely, the direction of the main beam). As a result, the radiation wave (more concretely, the main beam) can pass through the radome 2 with a high transmittance as mentioned above.

Further, because the supporting members 5 are disposed between the first radome layer 3 and the second radome layer 4, the gap layer 6 is formed. The use of a material suitable for the supporting members 5 makes it possible to achieve an improvement in the rigidity of the radome 2 while achieving a reduction in the weight of the radome 2.

Further, the supporting members 5 are arranged outside the region in the radome 2 through which the electric wave is to pass (more concretely, the region MB through which the main beam is to pass). As a result, the supporting members 5 can be prevented from obstructing the propagation of the radiation wave (more concretely, the main beam).

Further, each of the first and second radome layers 3 and 4 has a monolayer structure (refer to FIG. 2B). The use of the supporting members 5 makes it possible to ensure sufficient rigidity in the radar device 100 used for vehicles or the likes, while eliminating the need for making each of the first and second radome layers 3 and 4 have a layered structure. The simplification of the structure of the radome layers 3 and 4 can facilitate the manufacture of the radome layers 3 and 4.

### Embodiment 2

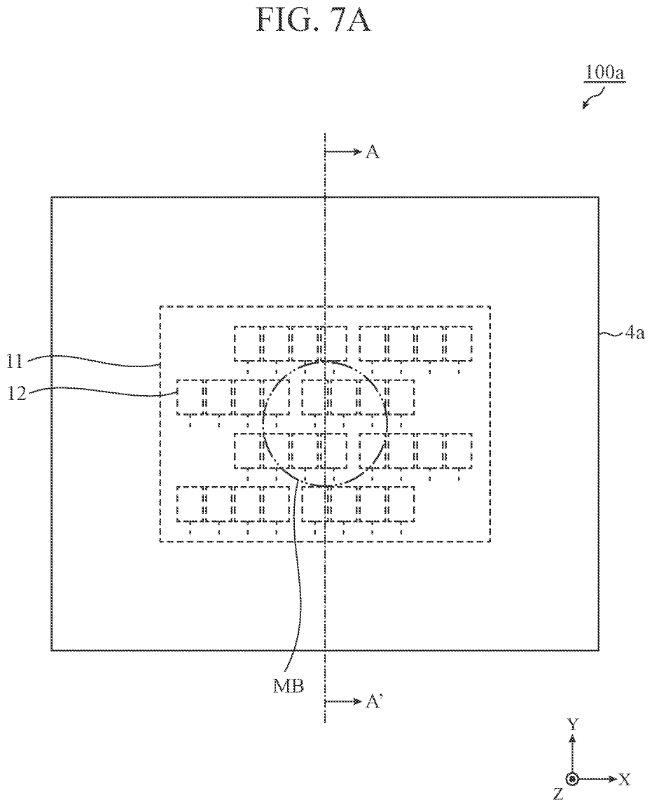

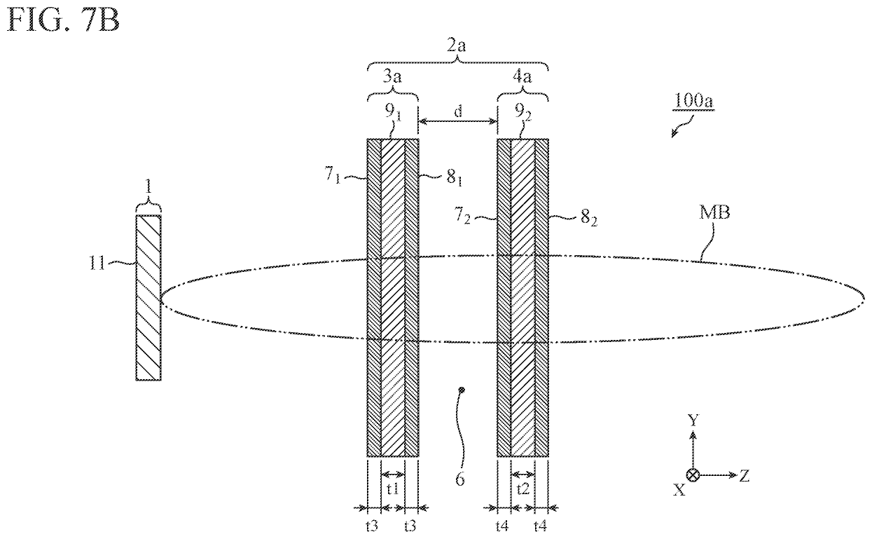

FIG. 7A is a front view showing a main part of a radar device according to Embodiment 2. FIG. 7B is a cross-sectional view taken along the line A-A′ shown in FIG. 7A. Referring to FIG. 7, the radar device 100a of Embodiment 2 will be explained. In FIG. 7, the same structural components as those shown in FIG. 2 and like structural components are denoted by the same reference symbols, and an explanation of the structural components will be omitted hereinafter.

In the radome 2 in the radar device 100 of Embodiment 1, each of the first and second radome layers 3 and 4 has a monolayer structure, as shown in FIG. 2B. In contrast with this, in a radome 2a in the radar device 100a of Embodiment 2, each of first and second radome layers 3a and 4a has a layered structure, as shown in FIG. 7B.

The first radome layer 3a has a structure in which a single core layer 9₁ is disposed between two coating layers 7₁ and 8₁. The coating layers 7₁ and 8₁ are constructed of, for example, a fluorine resin, such as polytetrafluoroethylene (PTFE), or a phenol resin. The core layer 9₁ is constructed of, for example, fiber-reinforced plastic, such as fiberglass reinforced plastic or quartz fiber-reinforced plastic. More specifically, the dielectric constant ε₁ of the coating layers 7₁ and 8₁ is smaller than that of the core layer 9₁. In the figure, t1 denotes the thickness of the core layer 9₁ in the first radome layers 3a.

The second radome layer 4a has a structure in which a single core layer 9₂ is disposed between two coating layers 7₂ and 8₂. The coating layers 7₂ and 8₂ are constructed of, for example, the same material as that of the coating layers 7₁ and 8₁. The core layer 9₂ is constructed of, for example, the same material as that of the core layer 9₁. More specifically, the dielectric constant ε₂ of the coating layers 7₂ and 8₂ is smaller than that of the core layer 9₂. In the figure, t2 denotes the thickness of the core layer 9₂ in the second radome layers 4a.

The gap d between the first radome layer 3a and the second radome layer 4a, more concretely, the gap d extending with respect to a direction of the thicknesses of the radome layers 3a and 4a (i.e. a direction extending along a Z axis in the figure) is set to a value corresponding to an integral multiple of one half of the wavelength of a radiation wave in a gap layer 6. More concretely, the gap d is set to the value based on the equation (1). More specifically, the gap d is set to the same value as that explained in Embodiment 1.

Here, the thickness t3 of each of the two coating layers 7₁ and 8₁ is set to a value corresponding to one quarter of the wavelength of the radiation wave in the coating layers 7₁ and 8₁. More concretely, the thickness t3 is set to a value based on the following equation (4). Further, the thickness t4 of each of the two coating layers 7₂ and 8₂ is set to a value corresponding to one quarter of the wavelength of the radiation wave in the coating layers 7₂ and 8₂. More concretely, the thickness t4 is set to a value based on the following equation (5).

t3=β₁×{λ₀/(4×√ε₁)} (4)

t4=β₂×{λ₀/(4×√ε₂)} (5)

β₁ is a coefficient satisfying the condition shown in the following equation (6). β₂ is a coefficient satisfying the condition shown in the following equation (7).

0.9≤β₁≤1.1 (6)

0.95≤β₂≤1.1 (7)

A main part of the radar device 100a is constructed in this way.

Next, advantages provided using the radome 2a in the radar device 100a will be explained.

First, because the layer having a low dielectric constant (i.e. the gap layer 6) is disposed between the first radome layer 3a and the second radome layer 4a, an improvement in the transmittance to electric waves such as millimeter waves can be achieved. Secondly, because the gap layer 6 is formed between the first radome layer 3a and the second radome layer 4a, a reduction in the weight of the radome 2a can be achieved. Thirdly, because each of the first and second radome layers 3a and 4a has a layered structure, an improvement in the rigidity of each of the first and second radome layers 3a and 4a can be achieved. Therefore, by providing either a structure (not illustrated) in which the number of supporting members 5 is reduced compared with that of the radome 2, or a structure (refer to FIG. 7) in which the supporting members 5 are eliminated, an improvement in the rigidity of the radome 2a can be achieved while a reduction in the weight of the radome 2a is achieved.

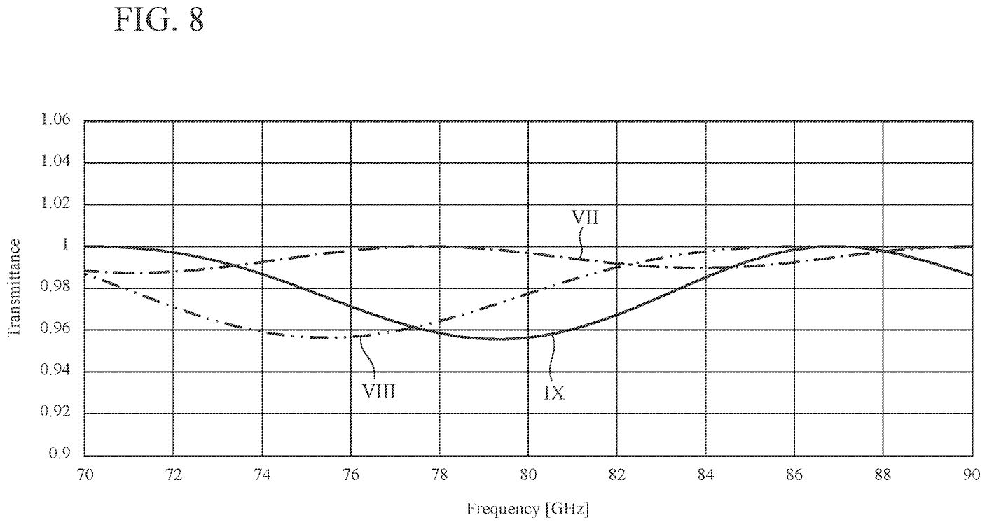

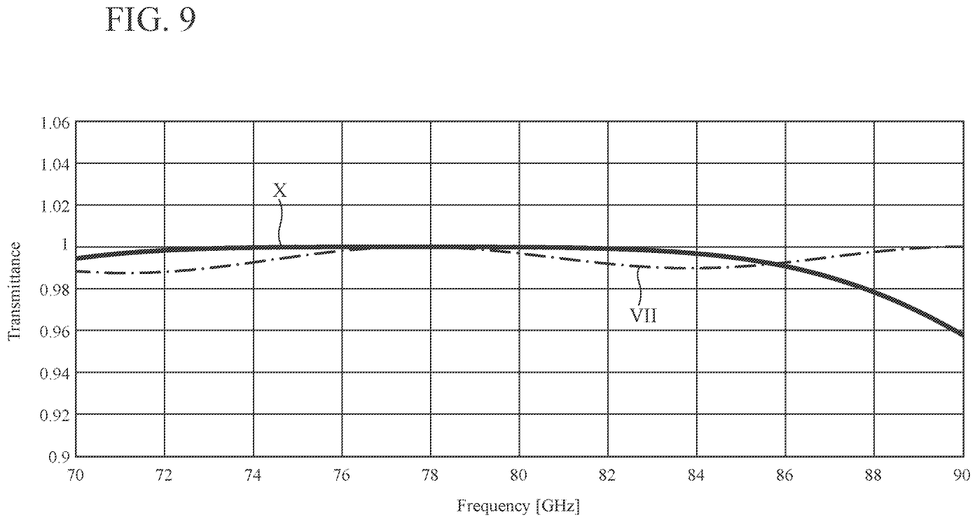

Further, because the gap d between the first radome layer 3a and the second radome layer 4a is set to the value based on the equation (1), the transmittance of the radome 2a to millimeter waves can be maximized at a carrier frequency f (e.g. 77 GHz). As a result, the transmittance to millimeter waves in a predetermined frequency range including the carrier frequency f can be improved. At this time, because the thickness t3 is set to the value based on the equation (4) and the thickness t4 is set to the value based on the equation (5), the frequency range in which an advantage of improving the transmittance to millimeter waves is provided can be expanded compared with that in the radome 2, as will be mentioned later by reference to FIGS. 8 and 9.

In FIGS. 8 and 9, each of characteristic lines VII, VIII, IX, and X shows the transmittance of the radome 2a to millimeter waves. These transmittance to millimeter waves are calculated using the Fresnel equations. In the calculation of these transmittance to millimeter waves, the dielectric loss is neglected and the Fresnel loss is set as a target for the calculation.

In the radome 2a associated with the characteristic line VII, the coating layers 7₁, 7₂, 8₁, and 8₂ are constructed of a phenol resin, and the core layers 9₁ and 9₂ are constructed of fiberglass reinforced plastic. The dielectric constant of this phenol resin is 2.0, and the dielectric constant of this fiberglass reinforced plastic is 4.0. In the radome 2a associated with the characteristic line VII, the gap is set to d=1.95 mm (more specifically, in the case of f=77 GHz, and n=1 and α=1.0). In the radome 2a associated with the characteristic line VII, the thicknesses t1 and t2 are set to t1=t2=0.97 mm. In the radome 2a associated with the characteristic line VII, the thicknesses t3 and t4 are set to t3=t4=0.69 mm (more specifically, in the case of f=77 GHz and ε₁=ε₂=2.0, and β₁=β₂=1.0). Hereinafter, the example of the structure of the radome 2a associated with the characteristic line VII is referred to as the “seventh structure example”.

In the radome 2a associated with the characteristic line VIII, the coating layers 7₁, 7₂, 8₁, and 8₂ are constructed of the same material as that in the seventh structure example, and the core layers 9₁ and 9₂ are constructed of the same material as that in the seventh structure example. In the radome 2a associated with the characteristic line VIII, the gap d is set to d=1.95 mm (more specifically, in the case of f=77 GHz, and n=1 and α=1.0). In the radome 2a associated with the characteristic line VIII, the thicknesses t1 and t2 are set to t1=t2=0.97 mm. In the radome 2a associated with the characteristic line VIII, the thicknesses t3 and t4 are set to t3=t4=0.62 mm (more specifically, in the case of f=77 GHz and ε₁=ε₂=2.0, and β₁=β₂=0.9). Hereinafter, the structure example of the radome 2a associated with the characteristic line VIII is referred to as the “eighth structure example”.

In the radome 2a associated with the characteristic line IX, the coating layers 7₁, 7₂, 8₁, and 8₂ are constructed of the same material as that in the seventh structure example, and the core layers 9₁ and 9₂ are constructed of the same material as that in the seventh structure example. In the radome 2a associated with the characteristic line IX, the gap d is set to d=1.95 mm (more specifically, in the case of f=77 GHz, and n=1 and α=1.0). In the radome 2a associated with the characteristic line IX, the thicknesses t1 and t2 are set to t1=t2=0.97 mm. In the radome 2a associated with the characteristic line IX, the thicknesses t3 and t4 are set to t3=t4=0.76 mm (more specifically, in the case of f=77 GHz and ε₁=ε₂=2.0, and β₁=β₂=1.1). Hereinafter, the structure example of the radome 2a associated with the characteristic line IX is referred to as the “ninth structure example”.

As shown in FIG. 8, even in the case of using any one of the radome 2a of the seventh structure example, the radome 2a of the eighth structure example, and the radome 2a of the ninth structure example, the Fresnel loss in a frequency range of approximately ±20% with respect to the carrier frequency f, more concretely, in a frequency range of 70 to 84 GHz can be reduced to 5% or less. Particularly, the use of the radome 2a of the seventh structure example makes it possible to reduce the Fresnel loss in this frequency range to 2% or less.

More specifically, not only in the case of β₁=1.0, but also in the case in which β₁ is within the range satisfying the condition shown in the equation (6), an advantage of improving the transmittance to millimeter waves is provided even in the case of β₁≠1.0. Similarly, not only in the case of β₂=1.0, but also in the case in which β₂ is within the range satisfying the condition shown in the equation (7), an advantage of improving the transmittance to millimeter waves is provided even in the case of β₂≠1.0. This shows not only in the case in which the direction of a main beam of an antenna 1 is set so as to extend along the direction of the thicknesses of the radome layers 3a and 4a (i.e. extend along the Z axis), but also in the case in which the direction of the main beam is set so as to be slightly inclined against the thickness direction, an advantage of achieving an improvement in the transmittance to millimeter waves is provided.

The radome 2a associated with the characteristic line X differs from the radome 2a of the seventh structure example in the values of the thicknesses t1 and t2, and the thicknesses are set to t1=t2=0.49 mm. Hereinafter, the example of the structure of the radome 2a associated with the characteristic line X is referred to as the “tenth structure example”.

As shown in FIG. 9, the use of the radome 2a of the seventh structure example makes it possible to reduce the Fresnel loss in the frequency range of 70 to 84 GHz to 2% or less. In contrast with this, the use of the radome 2a of the tenth structure example makes it possible to reduce the Fresnel loss in this frequency range to 1% or less. More specifically, in the case of using the radome 2a of the tenth structure example, the transmittance to millimeter waves in this frequency range can be further improved as compared with the case of using the radome 2a of the seventh structure example.

The material of the core layers 9₁ and 9₂ is not limited to fiber-reinforced plastic, such as fiberglass reinforced plastic or quartz fiber-reinforced plastic. The core layers 9₁ and 9₂ may be formed using a material different from these types of fiber-reinforced plastic as long as the material has a dielectric loss as small as those of these types of fiber-reinforced plastics.

Further, the material of the coating layers 7₁ and 8₁ is not limited to a fluorine resin or a phenol resin. The coating layers 7₁ and 8₁ may be formed using any type of material as long as the material has a smaller dielectric constant ε₁ than that of the core layer 9₁, and is suitable from the viewpoint of reinforcing the core layer 9₁ and achieving a reduction in the weight of the radome 2a and an improvement in the rigidity of the radome 2a.

Further, the material of the coating layers 7₂ and 8₂ is not limited to a fluorine resin or a phenol resin. The coating layers 7₂ and 8₂ may be formed using any type of material as long as the material has a smaller dielectric constant ε₂ than that of the core layer 9₂, and is suitable from the viewpoint of reinforcing the core layer 9₂ and achieving a reduction in the weight of the radome 2a and an improvement in the rigidity of the radome 2a.

Further, the radome 2a may have the same supporting members 5 as the radome 2. As a result, the rigidity of the radome 2a can be further improved. However, as mentioned above, the number of supporting members 5 in the radome 2a may be small compared with the number of supporting members 5 in the radome 2.

In addition, the radar device 100a can adopt various variants which are the same as those explained in Embodiment 1, i.e. the same various variants as those of the radar device 100. For example, the radiation wave is not limited to a millimeter wave. Further, the radar device 100a is not limited to a vehicle-mounted one.

As mentioned above, in the radar device 100a of Embodiment 2, each of the first and second radome layers 3a and 4a has a layered structure. Therefore, by providing either the structure (not illustrated) in which the number of supporting members 5 is reduced compared with that of the radome 2, or the structure (refer to FIG. 7) in which the supporting members 5 are eliminated, an improvement in the rigidity of the radome 2a can be achieved while a reduction in the weight of the radome 2a is achieved.

Further, the layered structure has the two coating layers 7 and 8 and the core layer 9 disposed between the two coating layers 7 and 8, and the thickness of each of the coating layers 7 and 8 is set to a value corresponding to one quarter of the wavelength of the electric wave. Because the thickness t3 is set to the value based on the equation (4) and the thickness t4 is set to the value based on the equation (5), the frequency range in which an advantage of reducing the Fresnel loss is provided can be expanded compared with that in the radome 2.

It is to be understood that any combination of two or more of the above-mentioned embodiments can be made, various changes can be made in any component according to any one of the above-mentioned embodiments, or any component according to any one of the above-mentioned embodiments can be omitted within the scope of the present disclosure.

### INDUSTRIAL APPLICABILITY

The radar device of the present disclosure can be used for, for example, vehicle-mounted millimeter wave radars.

### REFERENCE SIGNS LIST

1: antenna,
2 and 2a: radome,
3 and 3a: radome layer (first radome layer),
4 and 4a: radome layer (second radome layer),
5: supporting member,
6: gap layer,
7: coating layer,
8: coating layer,
9: core layer,
11: substrate,
12: antenna element, and
100 and 100a: radar device.

What is claimed is:

1. A radar device comprising:
an antenna to radiate an electric wave; and
a radome used for the antenna, the radome having a first radome layer, a second radome layer arranged opposite to the first radome layer, the second radome layer being the same in material and thickness as the first radome layer, and a gap layer formed between the first radome layer and the second radome layer,
wherein a gap between the first radome layer and the second radome layer is set to a value corresponding to one half of a wavelength of the electric wave, thereby maximizing transmittance of the radome at a carrier frequency of electric wave.

2. The radar device according to claim 1, wherein the gap extends with respect to a direction of radiation of the electric wave by the antenna.

3. The radar device according to claim 1, wherein the electric wave is a millimeter wave.

4. The radar device according to claim 1, wherein the radar device is used for vehicles.

5. The radar device according to claim 1, wherein the gap layer is formed by disposing a supporting member between the first radome layer and the second radome layer.

6. The radar device according to claim 2, wherein the gap layer is formed by disposing a supporting member between the first radome layer and the second radome layer.

7. The radar device according to claim 3, wherein the gap layer is formed by disposing a supporting member between the first radome layer and the second radome layer.

8. The radar device according to claim 4, wherein the gap layer is formed by disposing a supporting member between the first radome layer and the second radome layer.

9. The radar device according to claim 5, wherein the supporting member is arranged outside a region in the radome through which the electric wave is to pass.

10. The radar device according to claim 5, wherein each of the first and second radome layers has a monolayer structure.

11. The radar device according to claim 1, wherein each of the first and second radome layers has a layered structure.

12. The radar device according to claim 2, wherein each of the first and second radome layers has a layered structure.

13. The radar device according to claim 3, wherein each of the first and second radome layers has a layered structure.

14. The radar device according to claim 4, wherein each of the first and second radome layers has a layered structure.

15. The radar device according to claim 11, wherein the layered structure has two coating layers and a core layer disposed between the two coating layers, and a thickness of each of the coating layers is set to a value corresponding to one quarter of the wavelength of the electric wave.
